(19) United States
(12) Patent Application Publication
(10) Pub. No.: US 2024/0054620 A1
(43) Pub. Date: Feb. 15, 2024

(54) IMAGE PROCESSING METHOD, APPARATUS, ELECTRONIC DEVICE, AND READABLE STORAGE MEDIUM

(71) Applicant: VIVO MOBILE COMMUNICATION CO., LTD., Dongguan (CN)

(72) Inventor: Pu WU, Dongguan (CN)

(73) Assignee: VIVO MOBILE COMMUNICATION CO., LTD., Dongguan (CN)

(21) Appl. No.: 18/384,369

(22) Filed: Oct. 26, 2023

Related U.S. Application Data
(63) Continuation of application No. PCT/CN2022/089303, filed on Apr. 26, 2022.

(30) Foreign Application Priority Data
Apr. 30, 2021 (CN) 202110484867.9

(51) Int. Cl. G06T 5/00; G06T 5/50

(52) U.S. Cl. CPC G06T 5/003; G06T 5/50; G06T 2207/20021; G06T 2207/20221

(57) ABSTRACT

An image processing method, an electronic device, and a non-transitory computer readable storage medium are provided. The method includes: dividing a to-be-processed image into blocks to obtain a plurality of image blocks. Each image block includes an effective image area and an extended area. The method further includes processing image data of each image block by using a target network model to obtain each target image block. The method also includes extracting target effective image areas in each target image block separately. The method additionally includes combining the target effective image areas to generate a target image.

### CROSS-REFERENCE TO RELATED APPLICATIONS

This application is a continuation of International Application No. PCT/CN2022/089303, filed on Apr. 26, 2022, which claims priority to Chinese Patent Application No. 202110484867.9, filed on Apr. 30, 2021. The entire contents of each of the above-referenced applications are expressly incorporated herein by reference.

### TECHNICAL FIELD

Embodiments of the present disclosure relate to the field of image processing technologies, and in particular to an image processing method, an apparatus, an electronic device, and a readable storage medium.

### BACKGROUND

With the development of deep learning, many image processing algorithms need to be combined with deep learning networks to process images. Such image processing algorithm requires great computing power of hardware devices involved in image processing. Currently, although a processor in the electronic device can process one entire high-resolution image at a time, a processing speed is very slow. For some hardware in the electronic device, because the hardware has limitations, one entire image cannot be processed at a time and can only be divided into several image blocks that are processed separately.

An existing method for dividing an image is to simply divide an image into several image blocks. The image blocks after the division are input into a deep learning network. The deep learning network needs to fill in redundant information so that the deep learning network is adapted. After being processed by the deep learning network, the output image blocks are combined into a target image. Because the deep learning network fills in redundant information into image blocks when processing the image blocks, there are abnormal color spots at boundaries of each image block in the target image after combination. The boundaries are obvious.

### SUMMARY

Embodiments of this application are intended to provide an image processing method, an apparatus, an electronic device, and a readable storage medium.

This application is implemented as follows.

According to a first aspect, an embodiment of this application provides an image processing method. The method includes: dividing a to-be-processed image into blocks to obtain a plurality of image blocks, where each image block includes an effective image area and an extended area, processing image data of each image block by using a target network model to obtain each target image block, extracting target effective image areas in each target image block separately; and combining the target effective image areas to generate a target image.

According to a second aspect, an embodiment of this application provides an image processing apparatus. The apparatus includes, a dividing module, configured to divide a to-be-processed image into blocks to obtain a plurality of image blocks, where each image block includes an effective image area and an extended area; a processing module, configured to process image data of each image block by using a target network model to obtain each target image block; an extracting module, configured to extract target effective image areas in each target image block separately; and a combining module, configured to combine the target effective image areas to generate a target image.

According to a third aspect, an embodiment of this application provides an electronic device. The electronic device includes a processor, a memory, and a program or an instruction stored in the memory and capable of running on the processor. When the program or the instruction is executed by the processor, the steps of the method according to the first aspect are implemented.

According to a fourth aspect, an embodiment of this application provides a readable storage medium. The readable storage medium stores a program or an instruction, and when the program or the instruction is executed by a processor, steps of the method according to the first aspect are implemented.

According to a fifth aspect, an embodiment of this application provides a chip. The chip includes a processor and a communications interface, the communications interface is coupled to the processor, and the processor is configured to run a program or an instruction, to implement the method according to the first aspect.

In the embodiments of this application, a to-be-processed image is divided into a plurality of image blocks that include effective image areas and extended image areas. After each image block is input into a target network model, because each image block includes an extended area, redundant information does not need to be filled into the target network model so that the target network model is adapted. Therefore, there is no redundant information for an operation performed by the target network model on the boundaries of each image block. Because there is no redundant information for an operation performed by the target network model on the boundaries of each image block, there are no abnormal color spots at the boundaries of each image block in the target image generated after the image blocks are processed based on the target network model, and there are no obvious boundaries between the image blocks.

### BRIEF DESCRIPTION OF DRAWINGS

To describe the technical solutions of the embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a flowchart depicting steps of an image processing method according to an embodiment of this application;

FIG. 2 is a schematic diagram of an image processing process according to an embodiment of this application.

FIG. 3 is a block diagram depicting a structure of an image processing apparatus according to an embodiment of this application;

FIG. 4 is a block diagram depicting a structure of an electronic device according to an embodiment of this application; and

FIG. 5 is a schematic diagram of a hardware structure of an electronic device according to an embodiment of this application.

### DETAILED DESCRIPTION

The following clearly describes technical solutions in embodiments of this application with reference to the accompanying drawings in the embodiments of this application. Apparently, the described embodiments are some rather than all of the embodiments of this application. All other embodiments obtained by a person of ordinary skill in the art based on the embodiments of this application shall fall within the protection scope of this application.

The terms “first”, “second”, and the like in the description and the claims of this application are used to distinguish between similar objects, and do not need to be used to describe a specific order or sequence. It should be understood that, data used in such a way is interchangeable in proper circumstances, so that the embodiments of this application can be implemented in an order other than the order illustrated or described herein. Objects classified by “first”, “second”, and the like are usually of a same type, and the quantity of objects is not limited. For example, there may be one or more first objects. In addition, in the specification and the claims, “and/or” represents at least one of connected objects, and a character “/” generally represents an “or” relationship between associated objects.

The following describes in detail the image processing method provided in the embodiments of this application through specific embodiments and application scenarios thereof with reference to the accompanying drawings.

FIG. 1 is a flowchart depicting steps of an image processing method according to an embodiment of this application.

The image processing method in embodiments of this application includes the following steps.

Step 101: Divide a to-be-processed image into blocks to obtain a plurality of image blocks.

The to-be-processed image may be an RAW domain image. During an imaging process, affected by a real environment, an electronic device introduces a series of noises, thereby affecting quality of a generated target image. Originally, RAW means unprocessed. An RAW domain image is original data in which an image sensor converts a captured light source signal into a digital signal. Image information is captured in an RAW domain, so that the most original image information can be retained. Therefore, an image processing algorithm is usually used to process an RAW domain image. In the embodiments of this application, a to-be-processed RAW domain image is used as an example for description.

Hardware computing power for processing an image is limited, and one entire image cannot be processed at a time. Therefore, in the embodiments of this application, the to-be-processed image is divided into several image blocks that are processed separately. The image blocks after the division are input into a target network model for processing. The target network model is preset with image block alignment rules. The image block alignment rules include: a size of each image block, an arrangement method of image blocks, and the like. When the to-be-processed image is divided into image blocks, if the image is divided in a simple way, in a case that the image blocks after the division do not follow preset image block alignment rules in the target network model, an unaligned part needs to be filled in when the image blocks are input into the target network model. A filled-in content is considered as boundary redundant information. In a case that there is redundant information for an operation performed by the target network model on the boundaries of the image blocks, network boundaries of the image blocks that are processed cannot be truly aligned with real image boundaries. Therefore, there are abnormal color spots at the boundaries of each image block in target image formed by combining the processed image blocks, and the boundaries between the image blocks are obvious.

In the embodiments of this application, the to-be-processed image may be divided into image blocks based on the preset image block alignment rules in the target network model. After image data of the image blocks after the division is input into the target network model, boundary redundancy information does not need to be filled in.

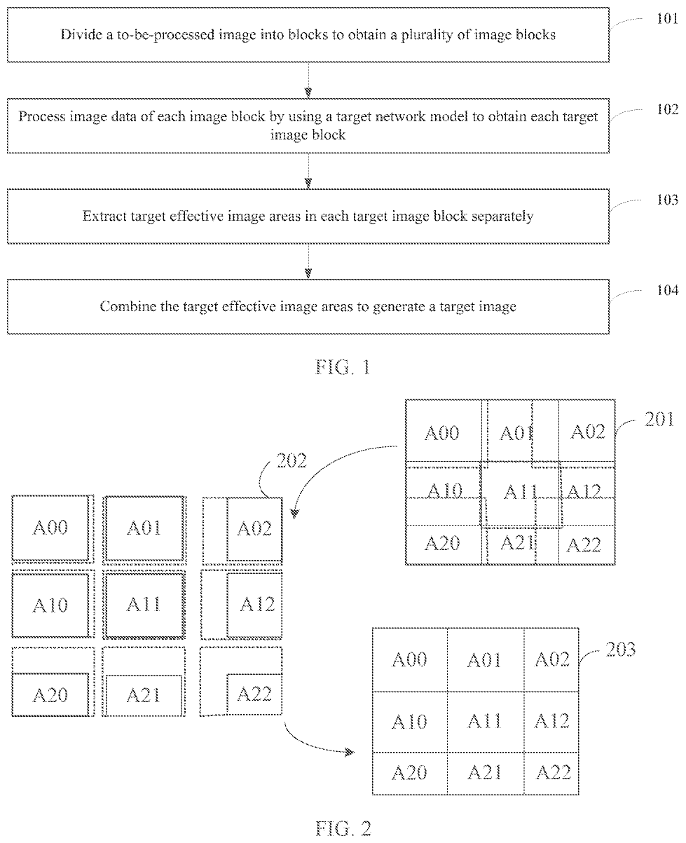

FIG. 2 is a schematic diagram of an image processing process. An image 201 in FIG. 2 is a to-be-processed RAW domain image Δn image 202 is image blocks stored in a memory corresponding to a target network model. The target network model obtains image data of the image blocks from the memory for deep learning Δn image 203 is a target image that is finally generated. As shown in FIG. 2, in the image processing method in the embodiments of this application, image data needs to be copied twice. At the first time, the image data is copied from an original RAW domain image to a memory corresponding to the target network model. In this case, it is necessary to consider from which location in the input image the image data starts to be copied, how much the image data should be copied, and how to store the image data in the memory corresponding to the target network model Δt the second time, after the target network model completes image processing, the output image data of the target network model is copied to generate the target image. In this case, it is necessary to consider from which position in the target image block output by the target network model the image data starts to be copied, how much the image data should be copied, and which location in the target image the image data should be placed.

A specific process of the image processing method in the embodiments of this application is described with reference to FIG. 2. The process may be roughly divided into four stages: step 101 is a stage at which a to-be-processed image is divided; step 102 is a stage at which image data is copied at the first time; step 103 is a stage at which the image data is processed based on a target network model; and step 104 is a stage at which the image data is copied at the second time and a target image is generated based on the copied image data. It should be noted that FIG. 2 is only an example. In an actual implementation process, it is unnecessary that the to-be-processed image is divided into 9 image blocks. The to-be-processed image may be divided into 4 image blocks, 16 image blocks, and the like. Rules of dividing a to-be-processed image into image blocks may be flexibly adjusted based on the preset image block alignment rules in the target network model.

As shown in the image 201 in FIG. 2, the RAW domain image is divided into a plurality of image blocks, and each image block includes an effective image area and an extended area. The effective image area is an area circled by a solid line, and the extended area is an area that is circled by a dashed line and an area other than the effective image area. When image data is input into the target network model, the image data of each image block circled by a dashed line is copied to the memory corresponding to the target network model. An image block corresponding to the input image data corresponds to an image area circled by a dashed line in the image 201. As shown in the image 202 in FIG. 2, although actually image data in the image area circled by a solid line needs to be processed, to ensure continuity of the image, actual effective image data is also placed in areas that are outside the area circled by a solid line and that are in the area circled by a dashed line. In this way, it is unnecessary to fill in redundant information to align the boundaries of the image blocks.

Step 102: Process image data of each image block by using a target network model to obtain each target image block.

In an actual implementation process, the image data of each image block may be copied to the memory corresponding to the target network model, and the image data may be obtained from the memory of the target network model.

Image data of an image block includes but is not limited to a pixel value of each pixel included in the image block. When the image block is copied, a storage location of the image block in the memory may be determined based on a location of each image block in the to-be-processed image. Each image block is stored at a corresponding location in the memory along boundaries of the image block.

The target network model can extract the image data of the image block from the memory at a plurality of times for deep learning, and generate a target image block based on the processed image data. The target network model can extract the image data from one or more image blocks at a time, and a quantity of image blocks extracted by the target network model may be flexibly adjusted based on computing power of the target network model.

Step 103: Extract target effective image areas in each target image block separately.

For each image block, after an image of the image block is input into the target network model for processing, the target image block indicated by the area circled by a dashed line in the image 202 may be formed. When finally, the target image is combined, the target effective image area needs to be extracted from the target image block. The target effective image area is an area circled by a solid line in the image 202, and the image data in the target effective image area is image data output from the target network model, that is, image data that is copied at the second time. The target effective image area corresponds to each area circled by a solid line in the image 203.

Step 104: Combine the target effective image areas to generate a target image.

In step 101 to step 103, processing of the to-be-processed image is completed based on the target network model, and finally the target effective image area corresponding to each image block is obtained. The target effective image areas are combined to generate the target image 203.

The specific method for combining the target effective image areas may be set by a person skilled in the art according to an actual need, and there is no specific restriction on this in the implementation example of this application. This is not limited in the embodiments of this application. For example, for an overlapping part in the combination, the target pixel value of each pixel in the overlapping part may be determined with reference to the weight corresponding to the image block and the pixel value of the pixel. For another example, for the overlapping part in the combination, the weight of each pixel may be flexibly determined based on the position of the pixel in the overlapping part, and the target pixel value of each pixel may be determined based on the weight and the pixel value of the pixel.

In the image processing method in the embodiments of this application, a to-be-processed image is divided into a plurality of image blocks that include effective image areas and extended image areas. After each image block is input into a target network model, because each image block includes an extended area, redundant information does not need to be filled into the target network model so that the target network model is adapted. Therefore, there is no redundant information for an operation performed by the target network model on the boundaries of each image block. Because there is no redundant information for an operation performed by the target network model on the boundaries of each image block, there are no abnormal color spots at the boundaries of each image block in the target image generated after the image blocks are processed based on the target network model, and there are no obvious boundaries between the image blocks.

In an embodiment, before the image data of each image block is processed by using the target network model to obtain each target image block, the image data of each image block may be copied to a memory corresponding to the target network model. The method for copying the image data of each image block to a memory corresponding to the target network model includes the following steps.

Step 1: Determine a storage location of the image data of each image block in a memory corresponding to the target network model based on a location of each image block in the to-be-processed image.

For example, one to-be-processed image is divided into total 9 image blocks that are arranged in three rows and three columns. The image block in the first row and the first column is also stored in the first row and first column in the memory.

Step 2: Store image data of a central image block around a center of the central image block, and storing the image data of each image block along a target boundary of each non-central image block separately.

Each image block includes one central image block and a plurality of non-central image blocks, and a boundary in which a boundary of an effective area of each image block overlaps a boundary of the image block is considered as the target boundary.

In such method for copying image data, the image blocks are placed in the memory along the boundaries of the image blocks, thereby making it easier to align the image blocks with network boundaries afterwards when the image data of the image blocks is input into the target network model.

In some embodiments, in a case that the to-be-processed image is divided into 9 image blocks that are arranged in three rows and three columns as shown in an image 201 in FIG. 2, when image data of a central image block is stored around a center of the central image block, and the image data of each image block is stored along a target boundary of each first image block separately, the image data may be stored in the following methods.

In the to-be-processed image 201 in FIG. 2, A00 is a first image block, A01 is a second image, A02 is a third image, A10 is a fourth image, A11 is a fifth image, A12 is a sixth image, A20 is a seventh image, A21 is an eighth image, and A22 is a ninth image.

Along an upper boundary and a left boundary of the first image block in the first row and the first column, image data of the first image block is stored.

Along an upper boundary of the second image block in the first row and the second column, image data of the second image block is stored.

Along an upper boundary and a right boundary of the third image block in the first row and the third column, image data of the third image block is stored.

Along a left boundary of the fourth image block in the second row and the first column, image data of the fourth image block is stored.

Around a center of the fifth image block in the second row and the second column, image data of the fifth image block is stored, and the fifth image block is the central image block.

Along a right boundary of the sixth image block in the second row and the third column, image data of the sixth image block is stored.

Along a lower boundary and a left boundary of the seventh image block in the third row and the first column, image data of the seventh image block is stored.

Along a lower boundary of the eighth image block in the third row and the second column, image data of the eighth image block is stored.

Along a lower boundary and a right boundary of the ninth image block in the third row and the third column, image data of the ninth image block is stored.

In such method for placing the image data of image blocks in the memory along the boundaries of the image blocks, after the image data of the image blocks is input into the target network model, accuracy of aligning the boundaries of the image blocks with the network boundaries is high.

In an embodiment, a method for combining target effective image areas to generate a target image includes the following steps
Step 1: Determine a location of each target effective image area based on a location of
each image block in the to-be-processed image.

Step 2: For each pixel in a part in which any two adjacent to-be-combined target effective image areas overlap, determine a first weight and a second weight corresponding to the pixel based on distances between the pixel and centers of the two to-be-combined target effective image areas.

The distances are inversely proportional to the first weight and the second weight.
Step 3: Determine a target pixel value corresponding to the pixel based on the first weight, the second weight, and a pixel value of the pixel in the two to-be-combined target effective image areas.

In some embodiments, a target pixel value corresponding to the pixel is determined based on the first weight, the second weight, and a pixel value of the pixel in the two to-be-combined target effective image areas by performing the following methods:
calculating a first product of the first weight and a first pixel value of the pixel in a to-be-combined first target effective image area, calculating a second product of the second weight and a second pixel value of the pixel in a to-be-combined second target effective image area; and determining an average value of the first product and the second product as the target pixel value corresponding to the pixel.

The first weight is a weight of the pixel in the first target effective image area, and the second weight is a weight of the pixel in the first target effective image area.

Such method for determining the target pixel value corresponding to the pixel has low computational complexity.

The foregoing example is an method for determining the target pixel value of the pixel based on the first weight and the second weight. In an actual implementation process, this is not limited. A person skilled in the art can flexibly set the method for determining the target pixel value according to an actual need.
Step 4 Adjust each pixel in the overlapping part to a corresponding target pixel value, so as to complete combination of the two to-be-combined target effective image areas.

In such method for combining the target effective image areas, each boundary in the target image after the combination has no color spots and a natural transition.

It should be noted that an execution subject of the image processing method according to an embodiment of this application may be an image processing apparatus, or a control module for performing the image processing method in the image processing apparatus. In the embodiments of this application, the image processing apparatus according to an embodiment of this application is described by using an example in which the image processing apparatus performs the image processing method.

FIG. 3 is a block diagram depicting a structure of an image processing apparatus according to an embodiment of this application.

The image processing apparatus 300 in the embodiments of this application includes the following functional modules:
a dividing module 301, configured to divide a to-be-processed image into blocks to obtain a plurality of image blocks, where each image block includes an effective image area and an extended area;
a processing module 302, configured to process image data of each image block by using a target network model to obtain each target image block;
an extracting module 303, configured to extract target effective image areas in each target image block separately; and
a combining module 304, configured to combine the target effective image areas to generate a target image.

In some embodiments, the apparatus further includes.
a location determining module, configured to determine a storage location of the image data of each image block in a memory corresponding to the target network model based on a location of each image block in the to-be-processed image before the processing module processes image data of each image block by using the target network model to obtain each target image block; and
a data copying module, configured to store image data of a central image block around a center of the central image block, and store the image data of each image block along a target boundary of each non-central image block separately, where each image block includes one central image block and a plurality of non-central image blocks, and a boundary in which a boundary of an effective area of each image block overlaps a boundary of the image block is considered as the target boundary.

In some embodiments, the data copying module is configured to:
in a case that the to-be-processed image is divided into 9 image blocks that are arranged in three rows and three columns, along an upper boundary and a left boundary of a first image block in the first row and the first column, store image data of the first image block;
along an upper boundary of a second image block in the first row and the second column, store image data of the second image block;
along an upper boundary and a right boundary of a third image block in the first row and the third column, store image data of the third image block;
along a left boundary of a fourth image block in the second row and the first column, store image data of the fourth image block;
around a center of a fifth image block in the second row and the second column, store image data of the fifth image block, where the fifth image block is the central image block;
along a right boundary of a sixth image block in the second row and the third column, store image data of the sixth image block;
along a lower boundary and a left boundary of a seventh image block in the third row and the first column, store image data of the seventh image block;
along a lower boundary of an eighth image block in the third row and the second column, store image data of the eighth image block; and
along a lower boundary and a right boundary of a ninth image block in the third row and the third column, store image data of the ninth image block.

In some embodiments, the combining module includes:
a first submodule, configured to determine a location of each target effective image area based on a location of each image block in the to-be-processed image;
a second submodule, configured to, for each pixel in a part in which any two adjacent to-be-combined target effective image areas overlap, determine a first weight and a second weight corresponding to the pixel based on distances between the pixel and centers of the two to-be-combined target effective image areas, where the distances are inversely proportional to the first weight and the second weight;
a third submodule, configured to determine a target pixel value corresponding to the pixel based on the first weight, the second weight, and a pixel value of the pixel in the two to-be-combined target effective image areas; and
a fourth submodule, configured to adjust each pixel in the overlapping part to a corresponding target pixel value, so as to complete combination of the two to-be-combined target effective image areas.

In some embodiments, the third submodule includes:
a first unit, configured to calculate a first product of the first weight and a first pixel value of the pixel in a to-be-combined first target effective image area, where the first weight is a weight of the pixel in the first target effective image area;
a second unit, configured to calculate a second product of the second weight and a second pixel value of the pixel in a to-be-combined second target effective image area, where the second weight is a weight of the pixel in the first target effective image area; and
a third unit, configured to determine an average value of the first product and the second product as the target pixel value corresponding to the pixel.

In the image processing apparatus in the embodiments of this application, a to-be-processed image is divided into a plurality of image blocks that include effective image areas and extended image areas. After each image block is input into a target network model, because each image block includes an extended area, redundant information does not need to be filled into the target network model so that the target network model is adapted. Therefore, there is no redundant information for an operation performed by the target network model on the boundaries of each image block. Because there is no redundant information for an operation performed by the target network model on the boundaries of each image block, there are no abnormal color spots at the boundaries of each image block in the target image generated after the image blocks are processed based on the target network model, and there are no obvious boundaries between the image blocks.

The image processing apparatus in this embodiment of this application as shown in FIG. 3 may be an apparatus, or a component, an integrated circuit, or a chip in a terminal. The apparatus may be a mobile electronic device, or may be a non-mobile electronic device. For example, the mobile electronic device may be a mobile phone, a tablet computer, a notebook computer, a palmtop computer, a vehicle-mounted terminal, a wearable device, an Ultra-Mobile Personal Computer (UMPC), a netbook, a Personal Digital Assistant (PDA), or the like. The non-mobile electronic device may be a Network Attached Storage (NAS), a Personal Computer (PC), a Television (TV), a teller machine, a self-service machine, or the like. This is not specifically limited in the embodiments of this application.

The image processing apparatus in the embodiments of this application as shown in FIG. 3 may be an apparatus with an operating system. The operating system may be an Android operating system, an iOS operating system, or another possible operating system, which is not specifically limited in the embodiments of this application.

The image processing apparatus provided in this embodiment of this application as shown in FIG. 3 can implement the processes implemented in the method embodiments in FIG. 1 to FIG. 2. To avoid repetition, details are not described herein again.

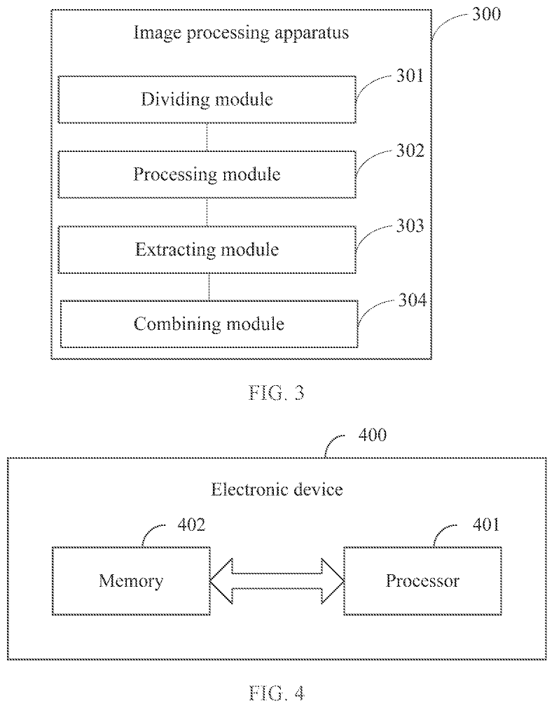

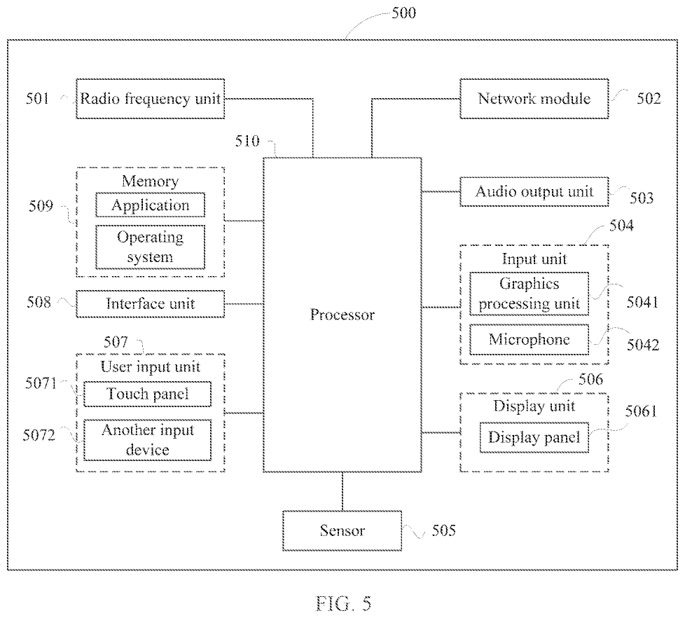

For example, as shown in FIG. 4, an embodiment of this application further provides an electronic device 400, including a processor 401, a memory 402, and a program or an instruction stored in the memory 402 and capable of running on the processor 401. When the program or the instruction is executed by the processor 401, the processes of the foregoing image processing method embodiments are implemented, with the same technical effects achieved. To avoid repetition, details are not described herein again.

It should be noted that the electronic device in the embodiments of this application includes the foregoing mobile electronic device and the foregoing non-mobile electronic device.

FIG. 5 is a schematic diagram of a hardware structure of an electronic device according to an embodiment of this application.

An electronic device 500 includes but is not limited to components such as a radio frequency unit 501, a network module 502, an audio output unit 503, an input unit 504, a sensor 505, a display unit 506, a user input unit 507, an interface unit 508, a memory 509, and a processor 510. It may be understood by a person skilled in the art that the electronic device 500 may further include a power supply (such as a battery) that supplies power to each component. The power supply may be logically connected to the processor 510 by using a power management system, to implement functions such as charging, discharging, and power consumption management by using the power management system. A structure of the electronic device shown in FIG. 5 does not constitute a limitation on the electronic device, and may include more or fewer components than those shown in the figure, or combine some components, or have different part arrangements. Details are not described herein again.

The processor 510 is configured to divide a to-be-processed image into blocks to obtain a plurality of image blocks, where each image block includes an effective image area and an extended area; process image data of each image block by using a target network model to obtain each target image block; extract target effective image areas in each target image block separately; and combine the target effective image areas to generate a target image.

In the electronic device in the embodiments of this application, a to-be-processed image is divided into a plurality of image blocks that include effective image areas and extended image areas. After each image block is input into a target network model, because each image block includes an extended area, redundant information does not need to be filled into the target network model so that the target network model is adapted. Therefore, there is no redundant information for an operation performed by the target network model on the boundaries of each image block. Because there is no redundant information for an operation performed by the target network model on the boundaries of each image block, there are no abnormal color spots at the boundaries of each image block in the target image generated after the image blocks are processed based on the target network model, and there are no obvious boundaries between the image blocks.

In some embodiments, before the image data of each image block is processed by using a target network model to obtain each target image block, the processor 510 is further configured to:
determine a storage location of the image data of each image block in a memory corresponding to the target network model based on a location of each image block in the to-be-processed image; and
store image data of a central image block around a center of the central image block, and store the image data of each image block along a target boundary of each non-central image block separately, where each image block includes one central image block and a plurality of non-central image blocks, and a boundary in which a boundary of an effective area of each image block overlaps a boundary of the image block is considered as the target boundary.

In some embodiments, in a case that the to-be-processed image is divided into 9 image blocks that are arranged in three rows and three columns, when the image data of the central image block is stored around the center of the central image block, and the image data of each image block is stored along the target boundary of each first image block separately, the processor 510 is configured to
along an upper boundary and a left boundary of a first image block in the first row and the first column, store image data of the first image block;
along an upper boundary of a second image block in the first row and the second column, store image data of the second image block;
along an upper boundary and a right boundary of a third image block in the first row and the third column, store image data of the third image block;
along a left boundary of a fourth image block in the second row and the first column, store image data of the fourth image block;
around a center of a fifth image block in the second row and the second column, store image data of the fifth image block, where the fifth image block is the central image block;
along a right boundary of a sixth image block in the second row and the third column, store image data of the sixth image block;
along a lower boundary and a left boundary of a seventh image block in the third row and the first column, store image data of the seventh image block;
along a lower boundary of an eighth image block in the third row and the second column, store image data of the eighth image block; and
along a lower boundary and a right boundary of a ninth image block in the third row and the third column, store image data of the ninth image block.

In some embodiments, when the target effective image areas are combined to generate a target image, the processor 510 is configured to:
determine a location of each target effective image area based on a location of each image block in the to-be-processed image;
for each pixel in a part in which any two adjacent to-be-combined target effective image areas overlap, determine a first weight and a second weight corresponding to the pixel based on distances between the pixel and centers of the two to-be-combined target effective image areas, where the distances are inversely proportional to the first weight and the second weight;
determine a target pixel value corresponding to the pixel based on the first weight, the second weight, and a pixel value of the pixel in the two to-be-combined target effective image areas; and
adjust each pixel in the overlapping part to a corresponding target pixel value, so as to complete combination of the two to-be-combined target effective image areas.

In some embodiments, when a target pixel value corresponding to the pixel is determined based on the first weight, the second weight, and a pixel value of the pixel in the two to-be-combined target effective image areas, the processor 510 is configured to.
calculate a first product of the first weight and a first pixel value of the pixel in a to-be-combined first target effective image area, where the first weight is a weight of the pixel in the first target effective image area;
calculate a second product of the second weight and a second pixel value of the pixel in a to-be-combined second target effective image area, where the second weight is a weight of the pixel in the first target effective image area; and
determine an average value of the first product and the second product as the target pixel value corresponding to the pixel.

It should be understood that, in this embodiment of this application, the input unit 504 may include a Graphics Processing Unit (GPU) 5041 and a microphone 5042, and the graphics processing unit 5041 processes image data of a still picture or a video obtained by an image capture apparatus (such as a camera) in a video capture mode or an image capture mode. The display unit 506 may include a display panel 5061. The display panel 5061 may be configured in a form such as a liquid crystal display or an organic light-emitting diode. The user input unit 507 includes a touch panel 5071 and another input device 5072. The touch panel 5071 is also referred to as a touchscreen. The touch panel 5071 may include two parts: a touch detection apparatus and a touch controller. The another input device 5072 may include but are not limited to a physical keyboard, a function key (for example, a volume control key or a switch key), an X trackball, a mouse, and a joystick. Details are not described herein. The memory 509 may be configured to store a software program and various data, including but not limited to an application program and an operating system. The processor 510 may be integrated with an application processor and a modem processor. The application processor mainly processes an operating system, a user interface, an application program, and the like. The modem processor mainly processes wireless communication. It can be understood that, in some alternative embodiments, the modern processor may not be integrated into the processor 510.

An embodiment of this application further provides a readable storage medium. The readable storage medium stores a program or an instruction. When the program or the instruction is executed by a processor, the processes in the foregoing image processing method embodiments are implemented, with the same technical effect achieved. To avoid repetition, details are not described herein again.

The processor is a processor in the electronic device in the foregoing embodiment. The readable storage medium includes a computer-readable storage medium such as a computer Read-Only Memory (ROM) a Random Access Memory (RAM), a magnetic disk, or an optical disc.

An embodiment of this application further provides a chip. The chip includes a processor and a communications interface, and the communications interface is coupled to the processor. The processor is configured to run a program or an instruction, to implement various processes of the foregoing image processing method embodiments, with the same technical effects achieved. To avoid repetition, details are not described herein again.

It should be understood that the chip mentioned in this embodiment of this application may also be referred to as a system-level chip, a system chip, a system on chip, a system chip on chip, and the like.

It should be noted that in this specification, the terms “include” and “comprise”, or any of their variants are intended to cover a non-exclusive inclusion, such that a process, a method, an article, or an apparatus that includes a list of elements not only includes those elements but also includes other elements that are not expressly listed, or further includes elements inherent to such a process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially, or the part contributing to the prior art may be implemented in a form of a computer software product. The software product is stored in a storage medium (for example, ROM/RAM, a magnetic disk, or an optical disc), and includes several instructions for instructing a terminal (which may be a mobile phone, a computer, a server, a network device, or the like) to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. An image processing method, comprising:
dividing a to-be-processed image into blocks to obtain a plurality of image blocks, wherein each image block comprises an effective image area and an extended area;
processing image data of each image block by using a target network model to obtain each target image block;
extracting target effective image areas in each target image block separately; and
combining the target effective image areas to generate a target image.

2. The image processing method according to claim 1, wherein before processing the image data of each image block by using the target network model to obtain each target image block, the method further comprises:
determining a storage location of the image data of each image block in a memory corresponding to the target network model based on a location of each image block in the to-be-processed image; and
storing image data of a central image block around a center of the central image block, and storing the image data of each image block along a target boundary of each non-central image block separately, wherein each image block comprises one central image block and a plurality of non-central image blocks, and a boundary in which a boundary of an effective area of each image block overlaps a boundary of the image block is considered as the target boundary.

3. The image processing method according to claim 2, wherein when the to-be-processed image is divided into 9 image blocks that are arranged in three rows and three columns, storing the image data of the central image block around the center of the central image block, and storing the image data of each image block along the target boundary of each non-central image block separately comprises:
along an upper boundary and a left boundary of a first image block in the first row and the first column, storing image data of the first image block;
along an upper boundary of a second image block in the first row and the second column, storing image data of the second image block;
along an upper boundary and a right boundary of a third image block in the first row and the third column, storing image data of the third image block;
along a left boundary of a fourth image block in the second row and the first column, storing image data of the fourth image block;
around a center of a fifth image block in the second row and the second column, storing image data of the fifth image block, wherein the fifth image block is the central image block;
along a right boundary of a sixth image block in the second row and the third column, storing image data of the sixth image block;
along a lower boundary and a left boundary of a seventh image block in the third row and the first column, storing image data of the seventh image block;
along a lower boundary of an eighth image block in the third row and the second column, storing image data of the eighth image block; and
along a lower boundary and a right boundary of a ninth image block in the third row and the third column, storing image data of the ninth image block.

4. The image processing method according to claim 1, wherein combining the target effective image areas to generate the target image comprises:
determining a location of each target effective image area based on a location of each image block in the to-be-processed image;
for each pixel in a part in which any two adjacent to-be-combined target effective image areas overlap, determining a first weight and a second weight corresponding to the pixel based on distances between the pixel and centers of the two to-be-combined target effective image areas, wherein the distances are inversely proportional to the first weight and the second weight;
determining a target pixel value corresponding to the pixel based on the first weight, the second weight, and a pixel value of the pixel in the two to-be-combined target effective image areas; and
adjusting each pixel in the overlapping part to a corresponding target pixel value, so as to complete combination of the two to-be-combined target effective image areas.

5. The image processing method according to claim 4, wherein determining the target pixel value corresponding to the pixel based on the first weight, the second weight, and the pixel value of the pixel in the two to-be-combined target effective image areas comprises:
calculating a first product of the first weight and a first pixel value of the pixel in a to-be-combined first target effective image area, wherein the first weight is a weight of the pixel in the first target effective image area;
calculating a second product of the second weight and a second pixel value of the pixel in a to-be-combined second target effective image area, wherein the second weight is a weight of the pixel in the second target effective image area; and
determining an average value of the first product and the second product as the target pixel value corresponding to the pixel.

6. An electronic device, comprising a processor; and a memory having a computer program or an instruction stored thereon, wherein the computer program or the instruction, when executed by the processor, causes the processor to perform operations comprising:
dividing a to-be-processed image into blocks to obtain a plurality of image blocks, wherein each image block comprises an effective image area and an extended area;
processing image data of each image block by using a target network model to obtain each target image block;
extracting target effective image areas in each target image block separately; and
combining the target effective image areas to generate a target image.

7. The electronic device according to claim 6, wherein before processing the image data of each image block by using the target network model to obtain each target image block, the operations further comprise:
determining a storage location of the image data of each image block in a memory corresponding to the target network model based on a location of each image block in the to-be-processed image; and
storing image data of a central image block around a center of the central image block, and storing the image data of each image block along a target boundary of each non-central image block separately, wherein each image block comprises one central image block and a plurality of non-central image blocks, and a boundary in which a boundary of an effective area of each image block overlaps a boundary of the image block is considered as the target boundary.

8. The electronic device according to claim 7, wherein when the to-be-processed image is divided into 9 image blocks that are arranged in three rows and three columns, storing the image data of the central image block around the center of the central image block, and storing the image data of each image block along the target boundary of each non-central image block separately comprises:
along an upper boundary and a left boundary of a first image block in the first row and the first column, storing image data of the first image block;
along an upper boundary of a second image block in the first row and the second column, storing image data of the second image block;
along an upper boundary and a right boundary of a third image block in the first row and the third column, storing image data of the third image block;
along a left boundary of a fourth image block in the second row and the first column, storing image data of the fourth image block;
around a center of a fifth image block in the second row and the second column, storing image data of the fifth image block, wherein the fifth image block is the central image block;
along a right boundary of a sixth image block in the second row and the third column, storing image data of the sixth image block;
along a lower boundary and a left boundary of a seventh image block in the third row and the first column, storing image data of the seventh image block;
along a lower boundary of an eighth image block in the third row and the second column, storing image data of the eighth image block; and
along a lower boundary and a right boundary of a ninth image block in the third row and the third column, storing image data of the ninth image block.

9. The electronic device according to claim 6, wherein combining the target effective image areas to generate the target image comprises:
determining a location of each target effective image area based on a location of each image block in the to-be-processed image;
for each pixel in a part in which any two adjacent to-be-combined target effective image areas overlap, determining a first weight and a second weight corresponding to the pixel based on distances between the pixel and centers of the two to-be-combined target effective image areas, wherein the distances are inversely proportional to the first weight and the second weight;
determining a target pixel value corresponding to the pixel based on the first weight, the second weight, and a pixel value of the pixel in the two to-be-combined target effective image areas; and
adjusting each pixel in the overlapping part to a corresponding target pixel value, so as to complete combination of the two to-be-combined target effective image areas.

10. The electronic device according to claim 9, wherein determining the target pixel value corresponding to the pixel based on the first weight, the second weight, and the pixel value of the pixel in the two to-be-combined target effective image areas comprises:
calculating a first product of the first weight and a first pixel value of the pixel in a to-be-combined first target effective image area, wherein the first weight is a weight of the pixel in the first target effective image area;
calculating a second product of the second weight and a second pixel value of the pixel in a to-be-combined second target effective image area, wherein the second weight is a weight of the pixel in the second target effective image area; and
determining an average value of the first product and the second product as the target pixel value corresponding to the pixel.

11. A non-transitory computer readable storage medium storing a computer program or an instruction that, when executed by a processor, causes the processor to perform operations comprising:
dividing a to-be-processed image into blocks to obtain a plurality of image blocks, wherein each image block comprises an effective image area and an extended area;
processing image data of each image block by using a target network model to obtain each target image block;
extracting target effective image areas in each target image block separately; and
combining the target effective image areas to generate a target image.

12. The non-transitory computer readable storage medium according to claim 11, wherein before processing the image data of each image block by using the target network model to obtain each target image block, the operations further comprise:
determining a storage location of the image data of each image block in a memory corresponding to the target network model based on a location of each image block in the to-be-processed image; and
storing image data of a central image block around a center of the central image block, and storing the image data of each image block along a target boundary of each non-central image block separately, wherein each image block comprises one central image block and a plurality of non-central image blocks, and a boundary in which a boundary of an effective area of each image block overlaps a boundary of the image block is considered as the target boundary.

13. The non-transitory computer readable storage medium according to claim 12, wherein when the to-be-processed image is divided into 9 image blocks that are arranged in three rows and three columns, storing the image data of the central image block around the center of the central image block, and storing the image data of each image block along the target boundary of each non-central image block separately comprises:
along an upper boundary and a left boundary of a first image block in the first row and the first column, storing image data of the first image block;
along an upper boundary of a second image block in the first row and the second column, storing image data of the second image block;
along an upper boundary and a right boundary of a third image block in the first row and the third column, storing image data of the third image block;
along a left boundary of a fourth image block in the second row and the first column, storing image data of the fourth image block;
around a center of a fifth image block in the second row and the second column, storing image data of the fifth image block, wherein the fifth image block is the central image block;
along a right boundary of a sixth image block in the second row and the third column, storing image data of the sixth image block;
along a lower boundary and a left boundary of a seventh image block in the third row and the first column, storing image data of the seventh image block;
along a lower boundary of an eighth image block in the third row and the second column, storing image data of the eighth image block; and
along a lower boundary and a right boundary of a ninth image block in the third row and the third column, storing image data of the ninth image block.

14. The non-transitory computer readable storage medium according to claim 11, wherein combining the target effective image areas to generate the target image comprises:
determining a location of each target effective image area based on a location of each image block in the to-be-processed image;
for each pixel in a part in which any two adjacent to-be-combined target effective image areas overlap, determining a first weight and a second weight corresponding to the pixel based on distances between the pixel and centers of the two to-be-combined target effective image areas, wherein the distances are inversely proportional to the first weight and the second weight;
determining a target pixel value corresponding to the pixel based on the first weight, the second weight, and a pixel value of the pixel in the two to-be-combined target effective image areas; and
adjusting each pixel in the overlapping part to a corresponding target pixel value, so as to complete combination of the two to-be-combined target effective image areas.

15. The non-transitory computer readable storage medium according to claim 14, wherein determining the target pixel value corresponding to the pixel based on the first weight, the second weight, and the pixel value of the pixel in the two to-be-combined target effective image areas comprises:
calculating a first product of the first weight and a first pixel value of the pixel in a to-be-combined first target effective image area, wherein the first weight is a weight of the pixel in the first target effective image area;
calculating a second product of the second weight and a second pixel value of the pixel in a to-be-combined second target effective image area, wherein the second weight is a weight of the pixel in the second target effective image area; and
determining an average value of the first product and the second product as the target pixel value corresponding to the pixel.
